(19) United States
(12) Patent Application Publication
(10) Pub. No.: US 2014/0157945 A1
(43) Pub. Date: Jun. 12, 2014

(54) DUAL MASS FLYWHEEL

(71) Applicant: Hyundai Motor Company, Seoul (KR)

(72) Inventors: Wan Soo Oh, Yongin-si (KR); Heung Seok Lee, Seoul (KR); Yong Wook Jin, Suwon-si (KR); Jae Woong Hwang, Yongin-si (KR)

(73) Assignee: Hyundai Motor Company, Seoul (KR)

(21) Appl. No.: 13/905,538

(22) Filed: May 30, 2013

(30) Foreign Application Priority Data
Dec. 10, 2012 (KR) 10-2012-0142614

(51) Int. Cl. F16F 15/30

(52) U.S. Cl. CPC F16F 15/30
USPC 74/572.2

(57) ABSTRACT

It is possible to prevent mounting performance from being deteriorated due to an increase in length of a transmission by mounting an inertia body not on the input shaft of the transmission and can effectively suppress rattling of the transmission by effectively reducing rotational vibration of the input shaft of the transmission, using 2-cylinder and 3-cylinder engines, down-speeding, or Cylinder Deactivation (CDA).

### CROSS-REFERENCE TO RELATED APPLICATION

The present application claims priority of Korean Patent Application Number 10-2012-0142614 filed Dec. 10, 2012, the entire contents of which application is incorporated herein for all purposes by this reference.

### BACKGROUND OF INVENTION

1. Field of Invention

The present invention relates to a dual mass flywheel, and more particularly, to a technology that reduces rattling of a transmission by suppressing rotational vibration of the input shaft of the transmission.

2. Description of Related Art

It is possible to efficiently avoid resonance in a specific frequency band where rattling of a transmission is a problem, by mounting an inertia plate on the input shaft of a transmission even without using a Dual Mass Flywheel (DMF) etc., as disclosed in Patent Documents 1 and 2 described below.

However, in the structure with an inertia plate on the input shaft of a transmission, a space is required on the input shaft to mount the inertia plate and it is required to enlarge the transmission case, so that it is difficult to mount the inertia plate or the length of the transmission is increased, which makes it difficult to mount the transmission on a vehicle.

Further, recently, as down-speeding of an engine is applied or 2- or 3-cylinder engines are used or a technology for improving fuel efficiency such as Cylinder Deactivation (CDA) is used, even using the DMF of the related art is not enough in some cases to effectively reduce rotational vibration of the input shaft of a transmission.

Exemplars of the prior art are Korean Patent Application Nos. KR 10-2007-0039819 A and KR 10-2009-0049295 A.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a dual mass flywheel that can prevent mounting performance from being deteriorated due to an increase in length of a transmission by mounting an inertia body not on the input shaft of the transmission and can effectively suppress rattling of the transmission by effectively reducing rotational vibration of the input shaft of the transmission, using 2-cylinder and 3-cylinder engines, down-speeding, or CDA.

Various aspects of the present invention provide for a dual mass flywheel including: a primary wheel; a secondary wheel that relatively rotates to the primary wheel; a DMF spring that elastically deforms with relative rotation between the primary wheel and the secondary wheel; a drive plate that is integrally connected with the secondary wheel and elastically deforms the DMF spring between the primary wheel and the drive plate; and an inertia plate that elastically rotates relatively to the drive plate.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating the structure of an exemplary dual mass flywheel according to the present invention.

FIG. 2 is a view illustrating the structure shown in FIG. 1 at another angle.

FIG. 3 is a view illustrating the principle and operation of an exemplary dual mass flywheel of the present invention.

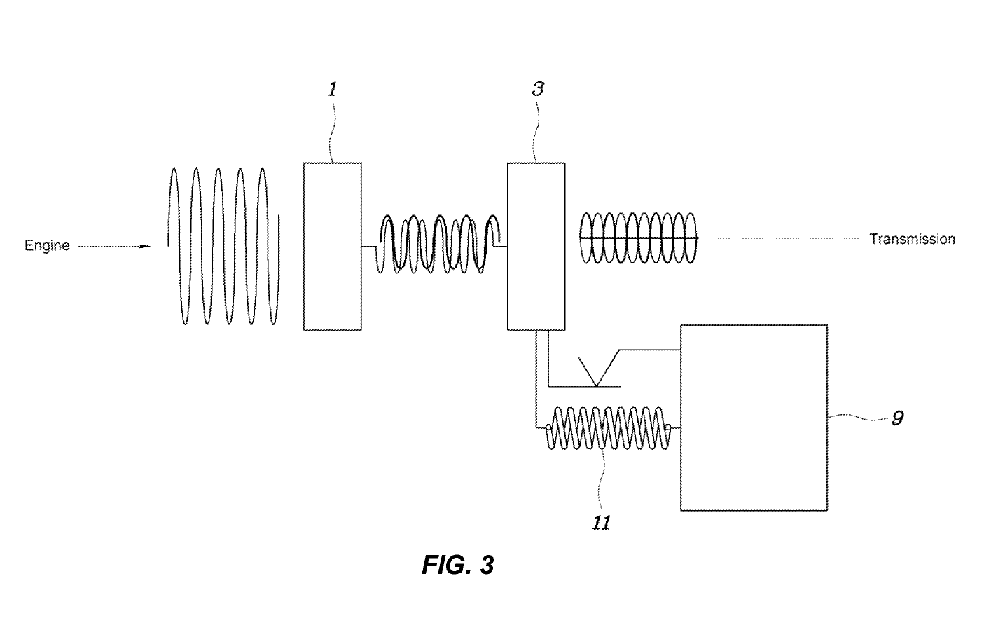

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

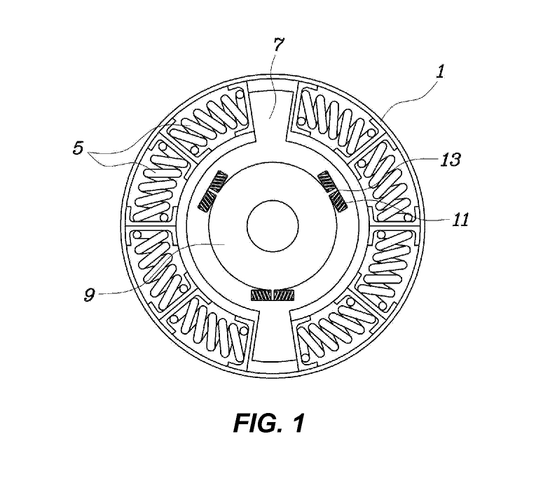

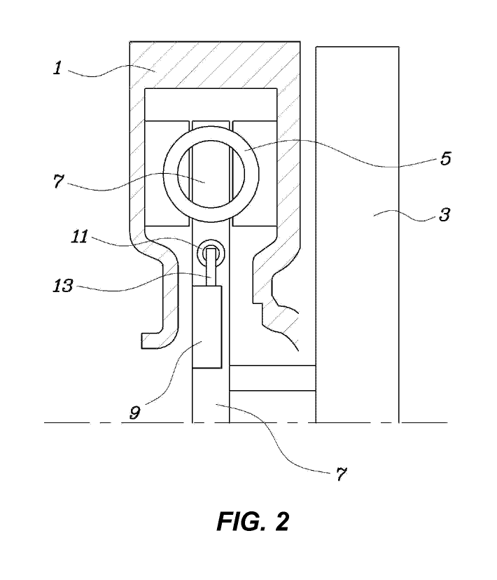

Referring to FIGS. 1 and 2, various embodiments of a dual mass flywheel of the present invention may include: a primary wheel 1; a secondary wheel 3 that can relatively rotate to the primary wheel 1; a DMF spring 5 that can elastically deform with relative rotation between the primary wheel 1 and the secondary wheel 3; a drive plate 7 that is integrally connected with the secondary wheel 3 and can elastically deform the DMF spring 5 between the primary wheel and the drive plate 7; and an inertia plate 9 that can elastically rotate relatively to the drive plate 7. One will appreciate that the drive plate may be monolithically formed with the secondary wheel.

That is, the configuration is implemented by adding the inertia plate 9, which can elastically rotate relatively to the drive plate 7, to the configuration of a dual mass plate of the related art and an Input Shaft Damper (ISD) that is mounted on the input shaft of a transmission is implemented in the dual mass plate so that it is possible to remove the problem that limits the space to mount the ISD without increasing the length of the input shaft of a transmission and to reduce or prevent rattling of the transmission.

The inertia plate 9 is connected with the inertia plate 9 by a tuning spring 11 inside the drive plate 7 and rotates while compressing or extending the tuning spring 11, when it relatively rotates.

In general, the primary wheel 1 is connected to the crankshaft of an engine and the secondary wheel 3 is connected to the input shaft of a transmission, so that the inertia plate 9 connected with the secondary wheel 3 by the tuning spring 11 provides the same effect as applying an inertia force to the input shaft of the transmission connected with the secondary wheel 3 through an elastic member, like the ISD of the related art.

In various embodiments, the inertia plate 9 is formed in a donut or toroidal shape arranged coaxially with the drive plate 7, a plurality of support protrusions 13 is disposed around the outer side of the donut shape, and the tuning spring 11 is disposed at both sides of the support protrusion 13.

Therefore, in transmission of power, as the inertia plate 9 and the drive plate 7 relatively rotate, the support protrusions 13 rotate while extending one side of the tuning spring 11 and compressing the other side, thereby elastically providing an inertia force to the input shaft of the transmission.

Further, an insertion groove to insert the inertia plate in is formed at one side of the drive plate 7 and the inertia plate 9 is inserted in the insertion groove of the drive plate 7 such that it is positioned inside the outer boundary of the drive plate 7, so that it is possible to implement the function of the ISD of the related art therein without increasing the volume of the DMF of the related art.

According to the present invention, it is possible to prevent mounting performance from being deteriorated due to an increase in length of a transmission by mounting an inertia body not on the input shaft of the transmission and can effectively suppress rattling of the transmission by effectively reducing rotational vibration of the input shaft of the transmission, using 2-cylinder and 3-cylinder engines, down-speeding, or CDA.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A dual mass flywheel comprising:
a primary wheel;
a secondary wheel that rotates relative to the primary wheel;
a Dual Mass Flywheel (DMF) spring that elastically deforms with relative rotation between the primary wheel and the secondary wheel;
a drive plate integrally connected with the secondary wheel and elastically deforms the DMF spring between the primary wheel and the drive plate; and
an inertia plate that elastically rotates relative to the drive plate.

2. The dual mass flywheel of claim 1, wherein the inertia plate is connected with the inertia plate by a tuning spring inside the drive plate and rotates while compressing or extending the tuning spring, when relatively rotating.

3. The dual mass flywheel of claim 2, wherein the inertia plate is formed in a toroidal shape arranged coaxially with the drive plate,
a plurality of support protrusions is disposed around the outer side of the toroidal shape, and
the tuning spring is disposed at both sides of the support protrusion.

4. The dual mass flywheel of claim 3, wherein an insertion groove to insert the inertia plate in is formed at one side of the drive plate and the inertia plate is inserted in the insertion groove of the drive plate to be is positioned inside the outer boundary of the drive plate.
